(19) United States
(12) Patent Application Publication
(10) Pub. No.: US 2016/0172880 A1
(43) Pub. Date: Jun. 16, 2016

(54) APPARATUS FOR TESTING AND CONDITIONING RECHARGEABLE BATTERIES

(71) Applicant: Paolo CANOVA, Montevarchi (IT)

(72) Inventor: Paolo CANOVA, Montevarchi (IT)

(21) Appl. No.: 14/902,740

(22) PCT Filed: Jul. 4, 2014
(86) PCT No.: PCT/IB2014/062857

§ 371 Date: Jan. 4, 2016

(30) Foreign Application Priority Data
Jul. 5, 2013 (IT) FI2013A000163

(51) Int. Cl. H02J 7/00

(52) U.S. Cl. CPC H02J 7/0021; H02J 7/007

(57) ABSTRACT

The present invention relates to an apparatus for testing and conditioning rechargeable batteries such that: it minimizes the communication times among the various converters of said apparatus which are connected in parallel, thus reducing the accesses to the communication data bus by the control module; it makes the response times of the feedback loop faster, the latter being connected to the power supply common to the group of converters connected in parallel, so as to thus make the adjustment of the voltage on the load more accurate.

### FIELD OF THE INVENTION

The present invention relates to the technical field of apparatuses for testing and conditioning rechargeable batteries, with particular reference to the apparatuses for testing and conditioning rechargeable batteries based on a plurality of voltage and current converters connected in parallel to a same load and controlled so as to distribute the overall current supplied among the various converters of said plurality of converters and so as to keep, in specific testing steps, a constant voltage at the ends of said load.

### BACKGROUND ART

The present apparatuses for testing and conditioning batteries—in particular as regards batteries of the so-called “advanced chemistry” or “high chemistry” type comprising lithium, nickel-metal hydrate, etc.—generally comprise a plurality of voltage and current converters, which may work independently or may be connected in parallel to a common load comprising one or more batteries. Said converters are connected to a common power supply line, generally of the three-phase alternating type, and to a data bus associated with a local controller adapted to interface with the single converters and with an external controller, generally consisting of a personal computer equipped with suitable software.

Said apparatuses for testing and conditioning batteries use control modules generally characterized by a feedback loop based on the value of the current supplied by each converter, according to a “centralized” architecture where there is a central control module to which all the voltage and current converters forming part of the testing apparatus are connected.

This “centralized” architecture has the advantage of allowing the user of the apparatus to configure the operation of the various converters by means of a software control outside the same apparatus, therefore without requiring any hardware modification. This architecture further allows each converter to be controlled as a single element or as a part of a group of converters arranged in parallel, in principle without restrictions as regards the number or position of said converters inside the apparatus. This need is felt when the apparatus also has to perform tests where currents greater than the rated current of a single converter are required, in which case the possibility of configuring via software programs the number of converters being active in the apparatus allows great flexibility of use and management.

The above-mentioned flexibility of use is very useful in the various conditioning cycles of “advanced chemistry” batteries that require charging and discharging cycles both at a constant current and at a constant voltage.

The battery constant voltage tests carried out with currents higher than the rated currents of the single converters are performed by connecting in parallel multiple converters and controlling the output voltage on the load (the battery or batteries being tested) by means of a feedback loop under voltage which acts by adjusting the total amount of the currents supplied by the various active converters, so that the output voltage remains, indeed, constant.

This real-time control is performed by the central control module which, after receiving the information relating to the current supplied by each converter and the battery voltage, adjusts said battery voltage by adjusting the currents of each converter, thus dividing them into approximately equal parts among the various existing converters by applying suitable current sharing algorithms.

This centralized architecture has a further advantage, which is that of providing the reading and processing of the data coming from the batteries being tested. Each active converter, in fact, sends the data concerning the current supplied to the central control module and, moreover, a single converter sends the data concerning the value of the voltage at the terminals of the battery being tested to the central control module. The readouts of these data, by the central control module, take place at time intervals from 1 ms to 100 ms.

The aforementioned data are primarily used for two purposes: the first one is to control the various converters; the second is to monitor the behavior of the apparatus whereby said data are suitably filtered and sent to said external controller and made available to the user to be displayed, analyzed and post-processed.

Therefore, in the control architecture of the apparatuses for testing and conditioning batteries of the prior art, all the data coming from the battery testing converge in the central control module and are processed therein for both control and post-processing.

It is apparent that the greater the number of converters arranged in parallel and the greater the number of readouts of current values that the control module shall perform, the greater will be the number of accesses to the data bus that said control module shall perform and therefore the slower will be the overall response of the feedback loop of the system with a clear reduction in promptness of the whole system and accuracy of adjustment of the output voltage on the load.

The above-mentioned problem, in the apparatuses of the prior art comprising, for example, 24 converters selectable to operate in parallel on a common load, often causes the number of converters which are actually enabled to operate in parallel at the same time to never be greater than 8.

Therefore, taking into account the above-listed problems related to the systems of the prior art, it is the main object of the present invention to provide a novel apparatus for testing and conditioning rechargeable batteries such that: it minimizes the communication times among the various converters of said apparatus which are connected in parallel, thus reducing the accesses to the communication data bus by the control module; it makes the response times of the feedback loop faster, the latter being connected to the power supply common to the group of converters connected in parallel, so as to thus make the adjustment of the voltage on the load more accurate.

### BRIEF DESCRIPTION OF THE DRAWINGS

FIG. 1 shows a general block diagram of the apparatus according to the present invention.

FIG. 1_bis shows a block diagram of a preferred embodiment of the apparatus according to the present invention.

FIG. 2 shows the typical pattern of the currents of the various converters connected in parallel according to the present invention, when adjusting the load.

FIG. 3 shows a block diagram of the structure of a voltage converter belonging to the apparatus according to the present invention.

### SUMMARY OF THE INVENTION

The present invention relates to an apparatus for testing and conditioning rechargeable batteries such that: it minimizes the communication times among the various converters of said apparatus which are connected in parallel, thus reducing the accesses to the communication data bus by the control module; it makes the response times of the feedback loop faster, the latter being connected to the power supply common to the group of converters connected in parallel, so as to thus make the adjustment of the voltage on the load more accurate.

### DETAILED DESCRIPTION OF THE INVENTION

The apparatus for testing and conditioning batteries according to the present invention is particularly applied to the field of systems comprising a plurality of voltage converters connected in parallel to supply power to a load in a constant voltage mode.

The apparatus according to the present invention is capable of optimizing the adjustment of the voltage on the load by the provision of a control loop such that it minimizes the data bus reading and access cycles of the control module, and such that it therefore allows a more accurate and prompt adjustment of voltage on the powered load.

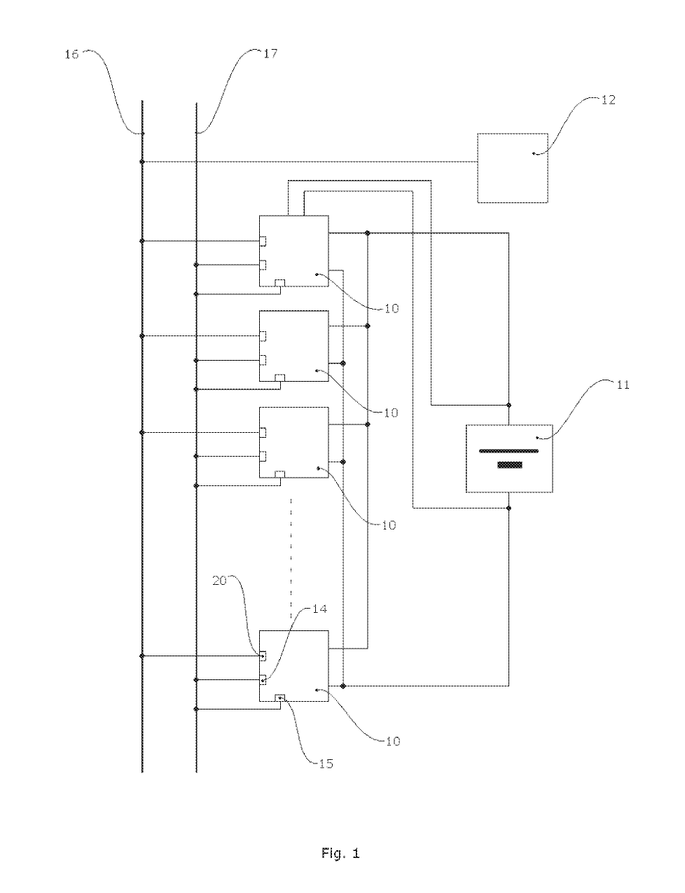

The idea behind the present invention includes the provision of a novel communication mode, such that it relieves the control module of the apparatus according to the present invention of a series of operations so as to speed up the control loop of the current supplied by the single converters arranged in parallel. With reference to the accompanying FIGS. 1 and 1_bis, said novel architecture maintains the main data bus 16 for the point-point connection between the central control module and the single converters, by introducing a secondary data bus 17, shared among the converters 10 and adapted to connect said converters 10 to one another in a closed daisy chain.

Said main data bus 16 is adapted to transfer the setting of the operating voltage/current value from said control module 12 to the converters configured as masters and to transfer the data relating to the actual operation from each converter to the central control module, which data are then sent to the external controller for post-processing and displaying operations performed by the user, the secondary data bus is instead intended to transfer, among the various active converters selected to operate in parallel, the data relating to the control loop, that is, the data for setting the current and/or the output voltage of each converter.

Thereby, the control loop of the current supplied by the various converters is much faster and thus adapted to allow a more accurate adjustment of the voltage on the load.

With reference to the accompanying figures, the apparatus according to the present invention comprises: a plurality of voltage converters 10 connected to the output terminals in parallel on a load 11; a central or local control module 12; an external or remote controller (not shown in the accompanying figures) provided with appropriate user interface, preferably consisting of a personal computer and associated with said central or local control module 12; a main data bus 16 adapted to connect each converter 10 to said central or local control module 12, and a secondary data bus 17 adapted to connect said converters 10 to one another preferably in a so-called daisy chain mode.

Each of said voltage converters 10 comprises in turn at least three communication ports: a first communication port 20 being adapted to establish connections to said local control module 12, a second 14 and a third 15 communication port being adapted to establish connections to other converters 10; at least one microprocessor 18 and a further processor 19, associated with said microprocessor 18 and dedicated to managing, in particular, the communication from and to said communication buses 16, 17, said dedicated processor 19 preferably being a programmable device, for example an FPGA (Field Programmable Gate Array) device.

Preferably, said communication ports 20, 14, 15 are of the RS485 full-duplex type, adapted to manage reception and transmission at the same time.

Said converters 10 are each connected to said control module 12 by means of said first communication port 20 and said main bus 16, and to at least another converter 10, by means of said secondary bus 17, in a so-called daisy chain configuration, in which each converter 10 receives, on said second communication port 14, data coming from the converter 10 positioned upstream and transmits, by means of said third communication port 15, said data to the converter 10 positioned downstream.

Said external or remote controller further comprises means adapted to configure said converters 10 as masters or slaves within said plurality of converters 10. The configuration of the slave converters and of the master converter preferably takes place by means of a software command that the user sends, by means of said external or remote controller and by means of said central or local control module 12, to the microprocessor 18 of the single converters 10 by means of said main data bus 16.

In accordance with the present invention, said converters 10 are configured so that said plurality of converters 10 may be divided in one or more groups, each of these comprising a single Master converter of a plurality of Slave converters.

Within each of said groups, the master converter is the converter performing the readout of the load voltage and receiving the setting of the operating voltage/current value from said control module 12 by means of said main data bus 16. Said master converter further sends the setting of the operating current value to the various slave converters associated therewith, by means of said secondary data bus 17. Said master converter and said slave converters further periodically send, according to the methods known in the systems of the prior art, the data relating to its own operation to said central or local control module 12, by means of said main data bus 16, to allow the user to possibly monitor, store or process said data by means of said external or remote controller.

With the control topology and method according to the present invention, unlike the case of conventional “current sharing” algorithms, where the main goal is to equally divide the currents among the various modules in parallel, the main goal is to promptly vary the overall load current so as to keep the voltage of the battery constant, by the action of the master converter which exclusively communicates with the other converters by means of said secondary bus 17.

Thereby, the various converters set as slaves according to the present invention do not need, as it happens instead in the systems of the prior art, to communicate with said central or local control module 12 in order to obtain the setting of the operating voltage/current value, which in the systems of the prior art requires a very high number of accesses to the communication bus towards said central or local control module 12, thus globally slowing the control loop down.

The present invention advantageously uses a double communication bus 16, 17 where said main data bus 16 is intended to accommodate the communication among the various converters and said central or local control module 12 (setting of the voltage/current value to be performed for the master and monitoring data relating to the operation for master and slaves), while said secondary data bus 17 is intended to exclusively accommodate the communication of the settings of the current value to be achieved from the masters to the corresponding slaves.

With reference to the accompanying FIG. 1_bis, in a preferred embodiment of the present invention said main data bus 16 comprises a plurality of point-point connections, adapted to connect each of said converters 10 to said central or local control module 12 so as to establish a full-duplex connection. In the same preferred embodiment of the present invention, said secondary data bus 17 comprises a bus passing through each of said converters 10. Said secondary data bus 17 is connected to each of said converters 10 through said second 14 and said third 15 communication ports. Since said secondary data bus 17 generally comprises 4 conductors, it may advantageously be made from a plurality of cables ended with an Ethernet connector.

The present invention, by the provision of said double communication bus 16, 17 and of the method described for transferring setting data from the master converters to the slave converters within each group of converters, allows avoiding the several accesses to a single communication bus by all of the converters of the system, which accesses are typical of the systems of the prior art, thus globally reducing the response time of the control loop of the current supplied from the typical 20 msec of the systems of the prior art to about 10 usec.

Time savings are very high since, as mentioned, according to the present invention, the accesses to a bus shared by a plurality of converters are avoided, which accesses often have to face long waiting times because of multiple concurrent requests.

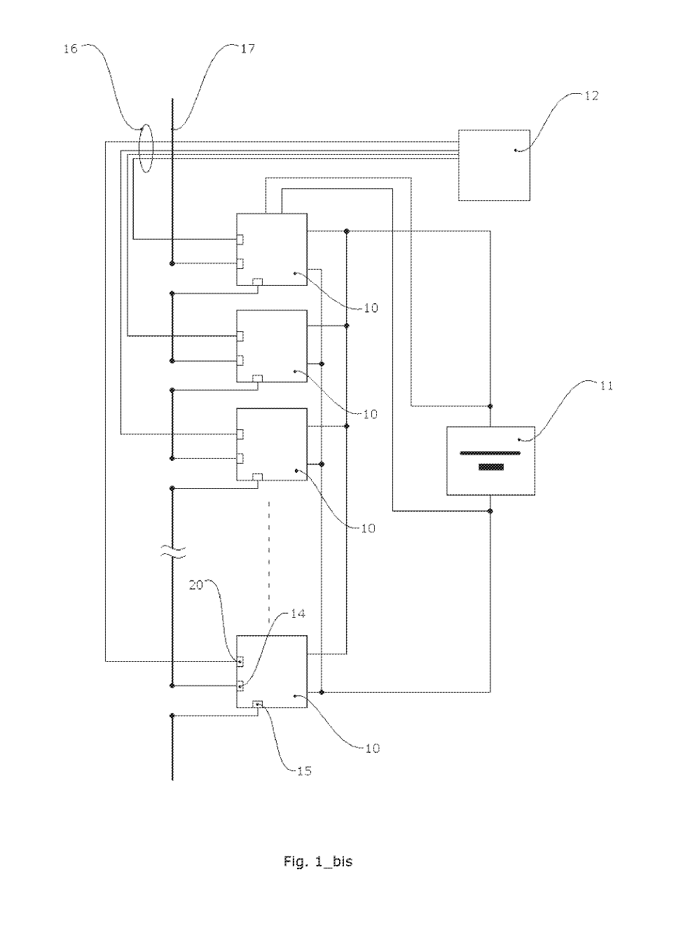

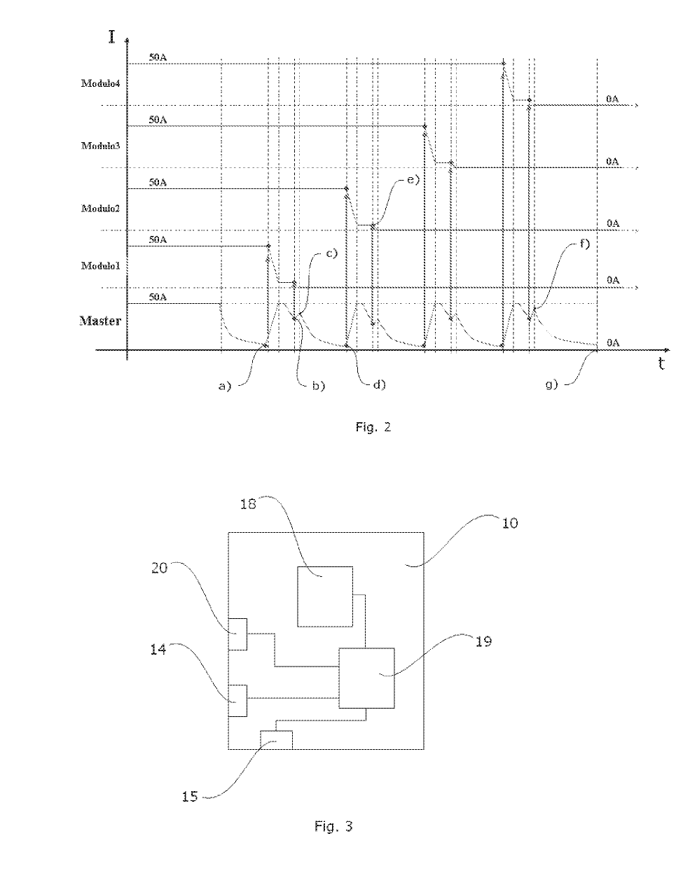

Achieving response times of as low as 10 usec allows to have a control loop with an available frequency band of about 10 kHz and therefore to accurately control each voltage variation on the load taking place at a frequency band of below 1 kHz. With reference to the accompanying FIG. 2, the pattern of the currents of the various converters connected in parallel according to the present invention is as follows. By way of example, we consider 5 converters connected in parallel, one of which is configured as the master. We consider that the load conditions undergo such a variation that requires the currents of the various converters to be reduced to zero in order to maintain the battery voltage constant.

Initially, the master converter adjusts the load voltage by lowering its own output current from an initial value, for example 50 A, to a threshold value, for example 5 A. At point (a), when the current of the Master has already dropped to about the threshold value of 5 A, said master converter accesses said secondary bus 17 to communicate to converter 1 to reduce its own current to the value of 5 A, thereafter the current of converter 1 is reduced to 5 A while the current of the master increases again to about 50 A in order to adjust the voltage on the load. Assuming that the load represented by the battery continues to decrease, the current of the master converter starts to drop again until, when the value of 40 A is achieved at point (b), for example, said master converter accesses said secondary bus 17 again and gives converter 1 the command to shut down. Thereafter, the master converter initially increases the current supply for adjusting the voltage on the load (point c) and then reduces again the current supplied until this decreases to a threshold value, for example 5 A (point d), at which point the procedure described hereinbefore is repeated, the master converter accesses said secondary bus 17 again and gives converter 2 the command to take its current to 5 A (point e) by repeating the procedure followed for converter 1.

The master converter repeats this procedure with all the converters until they are all shut down. At point (f), all the converters are shut down except for the master converter. The master converter continues to control its own load current by reducing it until complete shutdown is achieved at point (g).

In the example described, with a system of 5 converters in parallel, a total of 8 accesses to said secondary bus by the master converter are sufficient to control the overall load current using again the feedback loop inside the master converter and the secondary bus 17.

1. An apparatus for testing and conditioning rechargeable batteries, comprising: a plurality of voltage converters adapted to be connected, in use, to the output terminals in parallel to a common load; a central or local control module associated with said voltage converters; a remote controller, provided with appropriate user interface, associated with said local control module and comprising means adapted to configure said converters so as to split said plurality of voltage converters into at least one group comprising a single converter configured as master and at least one converter configured as slave; a main data bus adapted to connect each converter to said local control module, said master converter being adapted to read the voltage of said common load and to receive the setting of the operating voltage and/or current value from said local control module by means of said main data bus, characterized in that it comprises a secondary data bus adapted to connect said converters to one another and to transmit data related to the setting of the operating voltage and/or current value from said converter configured as master to said at least one converter configured as slave.

2. The apparatus according to claim 1, wherein said voltage converters comprise at least three communication ports: a first communication port adapted to establish connections to said local control module, a second communication port and a third communication port adapted to establish connections to other converters, at least one microprocessor and a further processor, associated with said microprocessor and dedicated to managing the communication from and to said communication buses.

3. The apparatus according to claim 1, wherein said converters are each connected to said local control module, by means of said first communication port and said main bus, and to at least another of said converters, through said secondary bus, in a so-called daisy chain configuration, in which each of said converters receives data from the converter positioned upstream, on said second communication port, and transmits said data towards the converter positioned downstream through said third communication port.

4. The apparatus according to claim 1, wherein said main data bus comprises a plurality of point-point connections, adapted to connect each of said converters to said local control module so as to establish a full-duplex connection, and wherein said secondary data bus comprises a bus passing through each of said converters, said secondary data bus being adapted to connect to each of said converters through said second communication port and said third communication port.

5. The apparatus according to claim 1, wherein said master converter and said slave converters are adapted to periodically send data related to its operation to said local control module, by means of said main data bus, so as to allow the user to possibly monitor, store or process said data by means of said remote controller.

6. The apparatus according to claim 1, wherein said dedicated processor comprises a programmable device.

7. The apparatus according to claim 1, wherein said communication ports are of the RS485 full-duplex type.
